(19) United States
(12) Patent Application Publication
(10) Pub. No.: US 2026/0266623 A1
(43) Pub. Date: Sep. 10, 2026

(54) SPATIAL INFORMATION OUTPUT DEVICE, SPATIAL INFORMATION OUTPUT METHOD, AND STORAGE MEDIUM

(71) Applicants: DENSO CORPORATION, Kariya-city (JP); J-QuAD DYNAMICS Inc., Tokyo (JP)

(72) Inventors: Mana HAYAKAWA, Tokyo (JP); Hiroki UKAI, Tokyo (JP); Masahiro GOTO, Tokyo (JP)

(21) Appl. No.: 19/555,209

(22) Filed: Mar. 3, 2026

(30) Foreign Application Priority Data
Mar. 7, 2025 (JP) 2025-036726

(51) Int. Cl. G01C 21/00; G06F 16/29

(52) U.S. Cl. CPC G01C 21/3815; G06F 16/29

(57) ABSTRACT

A spatial information output device includes an acquisition unit configured to acquire map information about an area determined based on position of a vehicle and an output unit configured to modify information contained in the map information and outputs the modified map information. The output unit changes a group direction to a vehicle direction in a case that the group direction differs from the vehicle direction.

### CROSS-REFERENCE TO RELATED APPLICATIONS

The present application claims priority to Japanese Application No. 2025-36726, filed on Mar. 7, 2025. The contents of this application are incorporated herein by reference in their entirety.

### BACKGROUND

### 1. Technical Field

The present disclosure relates to a spatial information output device, a spatial information output method, and a storage medium.

### 2. Related Art

JP2018173534A discloses a map generation device applied to a driving control system installed in a vehicle. The driving control system includes a driving control device and a detection device. The driving control device performs control to assist driver's driving operation using map information generated by a map generation device. The detection device has a camera and a radar device. The map generation device generates map information that is a high-precision map. The map generation device supplements connection relationships of links that are not defined in the map information. This enables the driving control system to predict the link in the vehicle's travelling direction even when the connection relationships of the links are not defined in the map information.

### SUMMARY

First aspect of this disclosure is a spatial information output device comprising: an acquisition unit configured to acquire map information about an area determined based on position of a vehicle, and an output unit configured to modify information contained in the map information and outputs the modified map information. The map information comprises at least one map tile information. Each of the at least one map tile information comprises at least one lane group information. Each of the at least one lane group information comprises at least one lane information and a group direction. Each of the at least one lane information comprises a start point and an end point of a corresponding lane, and a vehicle direction which is related to a vehicle. The group direction is a direction corresponding to the lane group information and either a direction from the start point toward the end point or a direction from the end point toward the start point. The output unit changes the group direction to the vehicle direction in a case that the group direction differs from the vehicle direction.

Second aspect of this disclosure is a spatial information output method performed by a computer comprising: acquiring map information about an area determined based on position of a vehicle, and modifying information contained in the map information and outputs the modified map information. The map information comprises at least one map tile information. Each of the at least one map tile information comprises at least one lane group information. Each of the at least one lane group information comprises at least one lane information and a group direction. Each of the at least one lane information comprises a start point and an end point of a corresponding lane, and a vehicle direction which is related to a vehicle. The group direction is a direction corresponding to the lane group information and either a direction from the start point toward the end point or a direction from the end point toward the start point. The modification includes changing the group direction to the vehicle direction in a case that the group direction differs from the vehicle direction.

Third aspect of this disclosure is a non-transitory computer-readable storage medium storing a spatial information output program, the spatial information output program causing a processor to perform: acquiring map information about an area determined based on position of a vehicle, and modifying information contained in the map information and outputs the modified map information. The map information comprises at least one map tile information. Each of the at least one map tile information comprises at least one lane group information. Each of the at least one lane group information comprises at least one lane information and a group direction. Each of the at least one lane information comprises a start point and an end point of a corresponding lane, and a vehicle direction which is related to a vehicle. The group direction is a direction corresponding to the lane group information and either a direction from the start point toward the end point or a direction from the end point toward the start point. The modification includes changing the group direction to the vehicle direction in a case that the group direction differs from the vehicle direction.

### BRIEF DESCRIPTION OF THE DRAWINGS

FIG. 1 is a configuration diagram of a vehicle system using a spatial information output device of an embodiment.

FIG. 2 is a diagram showing map information.

FIG. 3 is a flowchart showing processing of a position determination unit of the spatial information output device.

FIG. 4 is a flowchart showing processing of a spatial information output unit of the spatial information output device.

FIG. 5 is a diagram showing map information of a first example.

FIG. 6 shows map information processed by spatial information output unit.

FIG. 7 shows map information processed by spatial information output unit.

FIG. 8 is a diagram showing map information of a second example.

FIG. 9 shows map information processed by spatial information output unit.

FIG. 10 shows map information processed by spatial information output unit.

FIG. 11 is a diagram showing map information of a third example.

FIG. 12 shows map information processed by spatial information output unit.

FIG. 13 is a diagram showing map information of a fourth example.

FIG. 14 shows map information processed by spatial information output unit.

FIG. 15 shows map information processed by spatial information output unit.

FIG. 16 is a diagram showing map information of a fifth example.

FIG. 17 shows map information processed by spatial information output unit.

### DETAILED DESCRIPTION OF THE PREFERRED EMBODIMENTS

The map information generated by the map generation device described in JP2018173534A may include lane group information each corresponding to links and the direction of the lane group indicated by the lane group information.

Maintaining the map information requires significant cost and effort. The map information may include directional information regarding a vehicle (hereinafter, vehicle direction) and directional information regarding lane group information (hereinafter, group direction). In processes such as driving control using the map information, it is desirable for the vehicle direction and the group direction to be the same. However, due to the specifications of high-precision maps, they do not necessarily need to be identical. Consequently, the vehicle direction and the group direction in the map information may differ.

On the other hand, when the driving control device performs a driving operation assistance, which is a processing task using the map information, it is necessary that the vehicle direction and the group direction are unified. Furthermore, the driving control device may perform the driving operation assistance control using the processing result of fusion processing that fuses the map information, such as the map information generated by the map generation device, with information from the camera and radar devices. When the driving control device performs fusion processing, it is also necessary to unify the vehicle direction and the group direction. Therefore, in a case that the vehicle direction and the group direction differ, it is necessary to unify them each time the driving control device performs processing. Consequently, in a case where the vehicle direction and the group direction differ, the processing load on the driving control device increases. The map generation device described in JP2018173534A merely supplements the connection relationships of undefined links. Consequently, it may increase the processing load on the driving control device. Therefore, a technique that unifies the vehicle direction and the group direction is desired.

The present disclosure aims to provide a spatial information output device, a spatial information output method, and a storage medium capable of unifying the vehicle direction and the group direction.

The invention described in claim 1 is a spatial information output device comprising: an acquisition unit configured to acquire map information about an area determined based on position of a vehicle, and an output unit configured to modify information contained in the map information and outputs the modified map information. The map information comprises at least one map tile information. Each of the at least one map tile information comprises at least one lane group information. Each of the at least one lane group information comprises at least one lane information and a group direction. Each of the at least one lane information comprises a start point and an end point of a corresponding lane, and a vehicle direction which is related to a vehicle. The group direction is a direction corresponding to the lane group information and either a direction from the start point toward the end point or a direction from the end point toward the start point. The output unit changes the group direction to the vehicle direction in a case that the group direction differs from the vehicle direction.

The invention described in claim 11 is a spatial information output method performed by a computer comprising: acquiring map information about an area determined based on position of a vehicle, and modifying information contained in the map information and outputs the modified map information. The map information comprises at least one map tile information. Each of the at least one map tile information comprises at least one lane group information. Each of the at least one lane group information comprises at least one lane information and a group direction. Each of the at least one lane information comprises a start point and an end point of a corresponding lane, and a vehicle direction which is related to a vehicle. The group direction is a direction corresponding to the lane group information and either a direction from the start point toward the end point or a direction from the end point toward the start point. The modification includes changing the group direction to the vehicle direction in a case that the group direction differs from the vehicle direction.

The invention described in claim 12 is a non-transitory computer-readable storage medium storing a spatial information output program, the spatial information output program causing a processor to perform: acquiring map information about an area determined based on position of a vehicle, and modifying information contained in the map information and outputting the modified map information. The map information comprises at least one map tile information. Each of the at least one map tile information comprises at least one lane group information. Each of the at least one lane group information comprises at least one lane information and a group direction. Each of the at least one lane information comprises a start point and an end point of a corresponding lane, and a vehicle direction which is related to a vehicle. The group direction is a direction corresponding to the lane group information and either a direction from the start point toward the end point or a direction from the end point toward the start point. The modification includes changing the group direction to the vehicle direction in a case that the group direction differs from the vehicle direction.

According to these inventions, when the group direction differs from the vehicle direction, the group direction is changed to the vehicle direction, thereby unifying the vehicle direction and the group direction.

The reference symbols in parentheses attached to each component, etc., indicate an example of the correspondence between that component, etc., and the specific components, etc., described in the embodiments described later.

The following describes embodiments with reference to drawings. Identical or equivalent parts in the following embodiments are denoted by the same reference symbols, and their descriptions are omitted.

A spatial information output device performing a spatial information output method and a spatial information output program of this embodiment unifies the vehicle direction and the group direction. The spatial information output device is applied to a vehicle system. First, the configuration of the vehicle system is described.

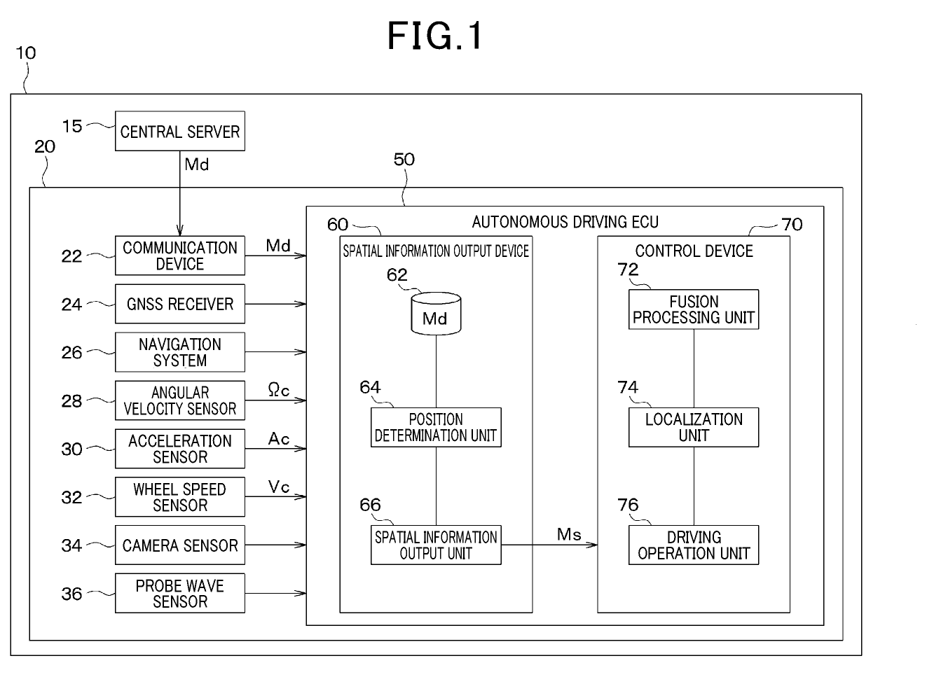

As shown in FIG. 1, the vehicle system 10 comprises a central server 15 and an own vehicle 20. The central server 15 is a computer device installed at an agency or facility. The central server 15 holds map information Md in a storage device.

The map information Md is high-precision map information created using the NDS. NDS stands for Navigation Data Standard. The NDS is a standardized database format for car navigation systems jointly developed by automobile manufacturers and suppliers.

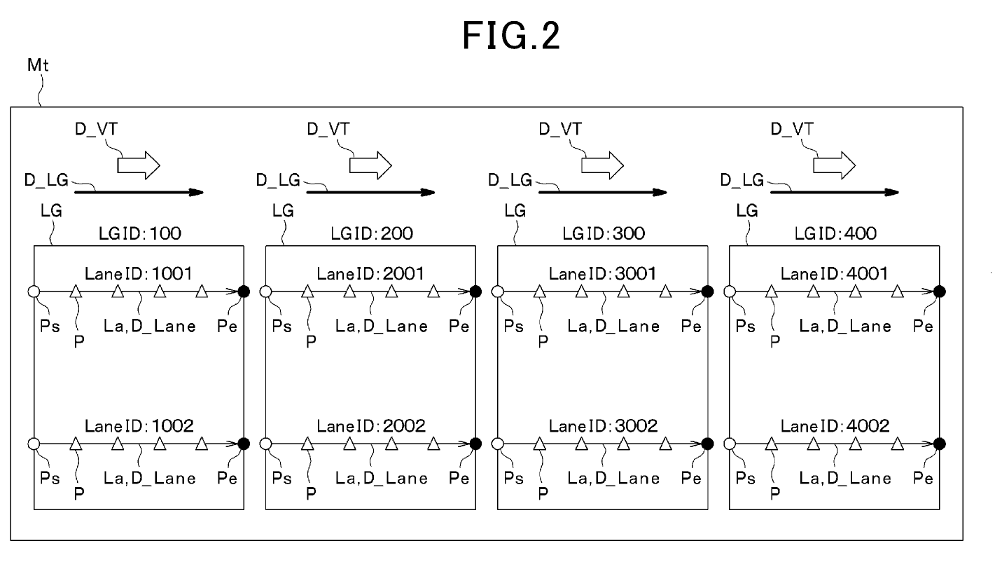

The map information Md includes at least one map tile information Mt. The map tile information Mt is a partial map information representing a portion of the map information Md. The map tile information Mt includes at least one lane group information LG, as shown in FIG. 2.

The lane group information LG includes lane information La, a group direction D_LG, and a group identification number LGID. The lane group information LG is information grouping multiple lane information La existing within the same road section.

The lane information La is information indicating each lane of a modeled road. The lane information La includes a vehicle direction D_VT, multiple lane shape points P, a lane direction D_Lane, and lane identification number Lane ID.

The vehicle direction D_VT is a direction of travelling of a vehicle. The vehicle direction D_VT is, for example, a direction of travelling observed by the vehicle mapped onto a lane in the map information. The vehicle direction D_VT is a direction along which the vehicle should travel in each lane.

Each of the multiple lane shape points P indicates a position on the lane indicated by the lane information La. Each of the lane shape point P is indicated by coordinates expressed as latitude, longitude, and altitude. The lane shape points P include a start point Ps and an end point Pe. The start point Ps indicates a starting point position of the lane indicated by lane information La. The end point Pe indicates an ending point position of the lane indicated by the lane information La.

The lane direction D_Lane is a digitizing direction of each lane indicated by lane information La. The lane direction D_Lane is a direction from the start point Ps toward the end point Pe.

The lane identification number Lane ID is an identification number of the lane information La. The lane identification number Lane ID may be set as, for example, 1001, 1002, 2001, 2002, 3001, 3002, 4001, 4002, etc. The lane identification number Lane ID is assigned to each lane information according to predetermined rules. For example, the lane information La may include information indicating ordering relationships between two of the lane identification number Lane ID of lane information La corresponding to lanes connected to each other, which is the ordering relationship according to lane direction D_Lane. For example, the start end of the lane represented by the lane information La with the lane identification number Lane ID 2001 is connected to the lane represented by the lane information La with the lane identification number Lane ID 1001.The end of the lane represented by the lane information La with the lane identification number Lane ID 2001 is connected to the lane represented by the lane information La with the lane identification number Lane ID 3001.In this case, the lane information La with the lane identification number Lane ID 2001 contains information that, in the ordering relationship, 1001 precedes 2001 and 3001 follows 2001.

The group direction D_LG is a direction associated with the lane group indicated by the lane group information D_LG. The group direction D_LG is a digitizing direction of the lane group information _LG. The group direction D_LG corresponds to either the same direction or the opposite direction of the lane direction D_Lane. In FIG. 2, the group direction D_LG is shown as having the same direction as the lane direction D_Lane, but it may also be in the opposite direction to the lane direction D_Lane.

The group identification number LGID is an identification number of the lane group information LG. The group identification number LGID may be set as, for example, 100, 200, 300, 400, etc. The group identification number LGID is assigned to each of the lane groups according to predetermined rules. The lane group information LG may include information indicating ordering relationships between two of the group identification number LGID corresponding to mutually connected lane groups, reflecting the ordering relationship according to group direction D_LG. For example, the start end of the lane group information LG with the group identification number LGID 200 is connected to the lane group information LG with the group identification number LGID 100.The end of the lane group information LG with the group identification number LGID 200 is connected to the lane group information LG with the group identification number LGID 300. In this case, the lane group information LG with the group identification number LGID 200 contains information that, in the ordering relationship, 100 precedes 200 and 300 follows 200.

As shown in FIG. 1, the own vehicle 20 travels on a road using a drive source such as an engine or a motor. The own vehicle 20 is provided with a communication device 22, a GNSS receiver 24, a navigation system 26, an angular velocity sensor 28, an acceleration sensor 30, a wheel speed sensor 32, a camera sensor 34, a probe wave sensor 36, and a autonomous driving ECU 50.

The communication device 22 has an interface for communicating with each of the central server 15 and the autonomous driving ECU 50.

The GNSS receiver 24 receives signals from a plurality of positioning satellites (not shown). The GNSS receiver 24 estimates the position of the own vehicle 20 based on the received signals. The GNSS receiver 24 transmits a signal corresponding to this estimated position of the own vehicle 20 to the autonomous driving ECU 50. The plurality of positioning satellites used by the GNSS receiver 24 include, for example, GPS satellites, GLONASS satellites, Galileo satellites, and Quasi-Zenith satellites.

The navigation system 26 provides route guidance for the own vehicle 20 to its destination. When providing the route guidance to the destination, the navigation system 26 transmits route guidance information to the autonomous driving ECU 50.

The angular velocity sensor 28 detects angular velocity Ωc of the own vehicle 20. The angular velocity sensor 28 transmits a signal corresponding to the detected angular velocity Ωc to the autonomous driving ECU 50. The angular velocity Ωc may include roll angular velocity, pitch angular velocity, and yaw angular velocity.

The acceleration sensor 30 detects acceleration Ac of the own vehicle 20. The acceleration sensor 30 transmits a signal corresponding to this detected acceleration Ac to the autonomous driving ECU 50. The acceleration Ac may include acceleration in the longitudinal direction of the own vehicle 20, acceleration in the lateral direction of the own vehicle 20, and acceleration in the vertical direction of the own vehicle 20.

The wheel speed sensor 32 detects the rotational speed of wheels of the own vehicle 20. The wheel rotational speed corresponds to vehicle speed Vc. The wheel speed sensor 32 transmits a signal indicating a value corresponding to the vehicle speed Vc to the autonomous driving ECU 50.

The camera sensor 34 includes a camera (not shown) and an image processing unit. The camera may be a monocular camera or a stereo camera. The camera captures images of surroundings of the own vehicle 20. The image processing unit may identify type of objects appearing in the captured image, for example, by matching object template images preset with the objects appearing in the image captured by the camera. The image processing unit may perform coordinate transformation from the image coordinate system to the vehicle coordinate system based on the camera's orientation and focal length, etc., and calculate a relative position of the object appearing in the image captured by the camera with respect to the own vehicle 20. The image processing unit transmits a signal corresponding to the calculated relative position, along with the object identification information, to the autonomous driving ECU 50.

The probe wave sensor 36 transmits probe waves, such as millimeter waves, sonar, and infrared waves, to objects surrounding the own vehicle 20. The probe wave sensor 36 also receives probe waves reflected by objects. The probe wave sensor 36 identifies type of the object based on information acquired from these probe waves and calculates relative position of the object with respect to the own vehicle 20. The probe wave sensor 36 transmits signals corresponding to the calculated relative position, along with the object identification information, to the autonomous driving ECU 50.

The autonomous driving ECU 50 is primarily configured with a microcontroller, etc. The autonomous driving ECU 50 includes a CPU, ROM, flash memory, RAM, I/O, communication interfaces, and bus lines connecting these components. Furthermore, autonomous driving ECU 50 includes a spatial information output device 60 and a control device 70.

The spatial information output device 60 includes a map storage 62, a position determination unit 64, and a spatial information output unit 66 as functional blocks.

Map information Md acquired from the central server 15 via the communication device 22 is stored in map storage 62.

The position determination unit 64 operates by executing a program stored in the ROM of the autonomous driving ECU 50. The position determination unit 64 acquires the map information Md from the map storage 62. The position determination unit 64 acquires the signals from the GNSS receiver 24, the angular velocity sensor 28, the acceleration sensor 30, and the wheel speed sensor 32. Based on the acquired map information Md and the signals, the position determination unit 64 determines the current position of the own vehicle 20 on the map information Md. This allows the position determination unit 64 to determine the lane information La on the map information Md where the own vehicle 20 is traveling. Furthermore, the position determination unit 64 outputs the current position of the own vehicle 20 and the map information Md to the spatial information output unit 66. Details of the processing performed by the position determination unit 64 will be described later.

The spatial information output unit 66 operates by executing the program stored in the ROM of the autonomous driving ECU 50. The spatial information output unit 66 acquires the current position of the own vehicle 20 and the map information Md from the position determination unit 64. The spatial information output unit 66 extracts map information Md pertaining to the area determined based on the current position of the own vehicle 20 from the acquired map information Md. Furthermore, the spatial information output unit 66 modifies the information contained in the extracted map information Md. Additionally, the spatial information output unit 66 outputs the modified map information Md as spatial information Ms to control device 70. Details of the processing performed by the spatial information output unit 66 will be described later.

The control device 70 includes a fusion processing unit 72, a localization unit 74, and a driving operation unit 76 as functional blocks.

The fusion processing unit 72 operates by executing a program stored in the ROM of the autonomous driving ECU 50. The fusion processing unit 72 acquires the object identification information and the relative positions of the objects from the camera sensor 34 and the probe wave sensor 36. Furthermore, the fusion processing unit 72 acquires the spatial information Ms from the spatial information output unit 66. The fusion processing unit 72 also fuses the information acquired from the camera sensor 34 and the probe wave sensor 36 with the spatial information Ms acquired from the spatial information output unit 66. For example, the fusion processing unit 72 may reflect the type and position of objects detected by the camera sensor 34 and the probe wave sensor 36 onto the map information Md contained within the spatial information Ms. The fusion processing unit 72 outputs the fused spatial information Ms to localization unit 74.

The localization unit 74 operates by executing a program stored in the ROM of the autonomous driving ECU 50. The localization unit 74 acquires the spatial information Ms fused by the fusion processing unit 72. Furthermore, the localization unit 74 determines the current position of the own vehicle 20 on the spatial information Ms fused by fusion processing unit 72. Through these processing, the localization unit 74 determines the lane information La corresponding to the lane on which the own vehicle 20 is traveling on the spatial information Ms fused by the fusion processing unit 72. Moreover, the localization unit 74 outputs the determined spatial information Ms to driving operation unit 76.

The driving operation unit 76 operates by executing a program stored in the ROM of the autonomous driving ECU 50. The driving operation unit 76 acquires the signals from the angular velocity sensor 28, the acceleration sensor 30, and the wheel speed sensor 32. Furthermore, the driving operation unit 76 acquires the spatial information Ms fused by fusion processing unit 72 and in which the current position of the own vehicle 20 has been determined, from the localization unit 74. Using these acquired signals and the spatial information Ms, the driving operation unit 76 automatically controls behavior of the own vehicle 20. For example, the driving operation unit 76 performs autonomous driving control of the own vehicle 20 by accelerating, decelerating, stopping, starting, turning right or left, etc. of the own vehicle 20. Consequently, the own vehicle 20 travels on the road without operation by the driver. The driving operation unit 76 is not limited to performing autonomous driving of the own vehicle 20 but may also perform driving assistance to support the operation of the driver.

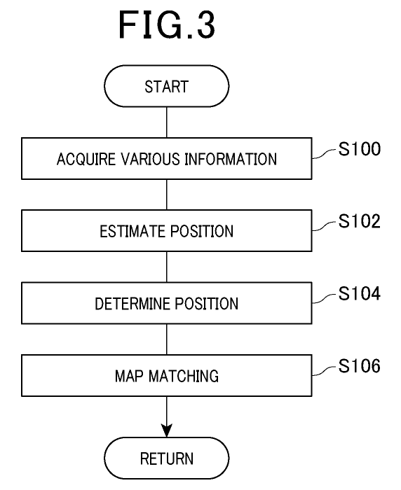

As described above, the vehicle system 10 is equipped with the spatial information output device 60. Next, the processing of the position determination unit 64 will be explained with reference to the flowchart shown in FIG. 3. The program for operating as the position determination unit 64 may, for example, be executed when the power of the own vehicle 20 is turned on. The period of operation from the start of processing step S100 of the position determination unit 64 until the processing returns to step S100 is the processing cycle of the position determination unit 64.

In step S100, the position determination unit 64 acquires various information. Specifically, the position determination unit 64 acquires the map information Md from the map information unit 62. The position determination unit 64 also acquires the position of the own vehicle 20 from the GNSS receiver 24. Furthermore, the position determination unit 64 acquires the angular velocity Ωc from the angular velocity sensor 28. The position determination unit 64 also acquires the acceleration Ac from the acceleration sensor 30. Additionally, the position determination unit 64 acquires the vehicle speed Vc from the wheel speed sensor 32.

In step S102, following step S100, the position determination unit 64 calculates a relative trajectory based on the current position determined in step S104 of the previous processing cycle and the angular velocity Ωc and the acceleration Ac acquired in step S100. The origin of the relative trajectory may be, for example, the current position determined in step S104 of the previous processing cycle. The position determination unit 64 estimates the position of the own vehicle 20 based on the calculated relative trajectory. The position determination unit 64 may calculate the relative trajectory using the vehicle speed Vc acquired in step S100 instead of the angular velocity Ωc and acceleration Ac acquired in step S100.

In step S104, following step S102, the position determination unit 64 performs composite navigation processing based on the position of the own vehicle 20 acquired from the GNSS receiver 24 in step S100 and the position of the own vehicle 20 estimated from the relative trajectory in step S102, thereby determining the current position of the own vehicle 20. For example, the position determination unit 64 may determine whether to use the position from the GNSS receiver 24 or the position from the relative trajectory to determine the position of the own vehicle 20 based on the respective accuracies of these positions. Instead of that, the position determination unit 64 may determine weighting coefficients for these positions based on these accuracies. The position determination unit 64 may correct either the position from the GNSS receiver 24 or the position from the relative trajectory based on the weighting coefficients. As a result, the position determination unit 64 determines the current position using the composite navigation.

In step S106, following step S104, the position determination unit 64 performs map matching process. Specifically, the position determination unit 64 matches the map information Md acquired in step S100 with the relative trajectory determined in step S104, using the current position as the end point. Through this, the position determination unit 64 determines the current position of the own vehicle 20 on the map information Md. The position determination unit 64 determines the lane information La on the map information Md corresponding to the lane on which the own vehicle 20 is traveling. The position determination unit 64 outputs the map information Md, on which the current position of the own vehicle 20 has been determined, to the spatial information output unit 66. Subsequently, the processing of the position determination unit 64 returns to step S100.

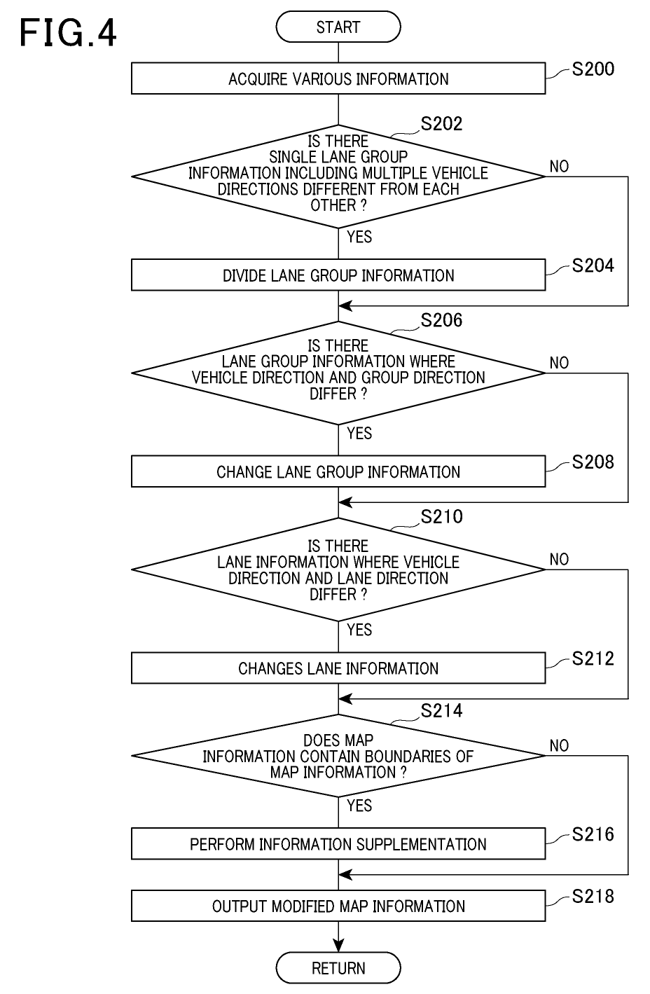

As described above, the position determination unit 64 performs its processing. Next, the processing of the spatial information output unit 66 will be explained with reference to the flowchart shown in FIG. 4. The program for operating as the spatial information output unit 66 may, for example, be executed when the power of the own vehicle 20 is turned on.

In step S200, the spatial information output unit 66 acquires various information. Specifically, the spatial information output unit 66 acquires signals from the navigation system 26. Furthermore, the spatial information output unit 66 acquires the map information Md, where the current position of the own vehicle 20 has been determined, from the position determination unit 64.

The spatial information output unit 66 extracts the map information Md for the area determined based on the current position of the own vehicle 20 from the acquired map information Md. Thus, the spatial information output unit 66 acquires the map information Md for the area determined based on the current position of the own vehicle 20. The area determined based on the current position of the own vehicle 20 is, for example, the road and its surrounding area within a certain distance along the road, using the current position of the own vehicle 20 as a reference. Furthermore, when a route guidance is provided by the navigation system 26, the area determined based on the current position of the own vehicle 20 may be the road and its surrounding area extending over a longer distance than the road forming the guided route.

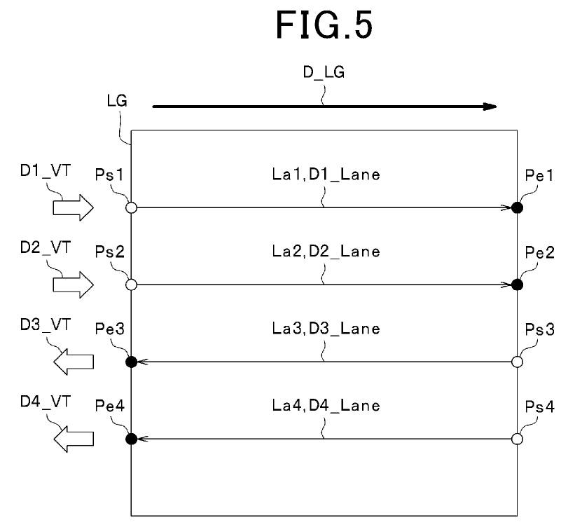

In a first example shown in FIG. 5, the lane group information LG includes a lane represented by a first lane information La1, a lane represented by a second lane information La2, a lane represented by a third lane information La3, and a lane represented by a fourth lane information La4. In FIG. 5, to avoid complexity, lane shape points P other than those for the start point Ps and end the point Pe, the group identification numbers LGID, and the lane identification numbers Lane ID are omitted.

The first lane information La1 includes a first vehicle direction D1_VT, a first start point Ps1, a first end point Pe1, and a first lane direction D1_Lane. The first vehicle direction D1_VT is one of the vehicle directions. The first start point Ps1 is a start point of the lane represented by the first lane information La1. The first end point Pe1 is an end point of the lane represented by the first lane information La1. The first lane direction D1_Lane is a direction from the first start point Ps1 toward the first end point Pe1.

The second lane information La2 includes a second vehicle direction D2_VT, a second start point Ps2, a second end point Pe2, and a second lane direction D2_Lane. The second vehicle direction D2_VT is one of the vehicle directions. The second start point Ps2 is a start point of the lane represented by the second lane information La2. The second end point Pe2 is an end point of the lane represented by the second lane information La2. The second lane direction D2_Lane is a direction from the second start point Ps2 toward the second end point Pe2.

The third lane information La3 includes a third vehicle direction D3_VT, a third start point Ps3, a third end point Pe3, and a third lane direction D3_Lane. The third vehicle direction D3_VT is one of the vehicle directions. The third start point Ps3 is a start point of the lane represented by the third lane information La3. The third end point Pe3 is an end point of the lane represented by the third lane information La3. The third lane direction D3_Lane is a direction from the third start point Ps3 toward the third end point Pe3.

The fourth lane information La4 includes a fourth vehicle direction D4_VT, a fourth start point Ps4, a fourth end point Pe4, and a fourth lane direction D4_Lane. The fourth vehicle direction D4_VT is one of the vehicle directions. The fourth start point Ps4 is a start point of the lane represented by the fourth lane information La4. The fourth end point Pe4 is an end point of the lane represented by the fourth lane information La4. The fourth lane direction D4_Lane is a direction from the fourth start point Ps4 toward the fourth end point Pe4.

In the map information Md, a road including a lane with a first direction and a lane with a second direction may be represented by a single lane group information LG. The lane with the first direction is the lane heading toward the base position. The base position is a position where the national highway begins. A national highway is a road constructing a trunk road network and managed by the national government. The lane with the second direction is the lane heading toward the terminus position. The terminus position is a position where the national highway ends. The second direction is the opposite direction of the first direction.

For example, the first vehicle direction D1_VT, the second vehicle direction D2_VT, the first lane direction ED1_Lane, the second lane direction ED2_Lane, and group direction D_LG may be in the same direction. The third vehicle direction D3_VT, fourth vehicle direction D4_VT, third lane direction ED3_Lane, and fourth lane direction ED4_Lane may be in the same direction. The first vehicle direction D1_VT and second vehicle direction D2_VT may be in a different direction from the third vehicle direction D3_VT and fourth vehicle direction D4_VT. The first lane direction D1_Lane, the second lane direction D2_Lane, and group direction D_LG are in a different direction from the third lane direction D3_Lane and the fourth lane direction D4_Lane. In this way, when a lane with the first direction and lane with the second direction are represented by a single lane group information LG, multiple vehicle directions D_VT that are mutually different may be associated with the single lane group information LG.

In this case, either the data concerning the lane with the first direction or the data concerning lane with the second direction may become unnecessary in the processing using the map information Md performed by the control device 70.

Therefore, in step S202 following step S200 in the flowchart of FIG. 4, the spatial information output unit 66 determines whether a single lane group information LG includes multiple vehicle directions D_VT that are different from each other. Through this, the spatial information output unit 66 determines whether the lane with the first direction and lane with the second direction are represented by a single lane group information LG.

In a case that no single lane group information LG includes multiple vehicle directions D_VT that are different from each other, the spatial information output unit 66 determines that the road lane with the first direction and lane with the second direction are not represented by a single lane group information LG. Thereafter, the processing of the spatial information output unit 66 proceeds to step S206. On the other hand, in a case that a single lane group information LG includes multiple vehicle directions D_VT that are different from each other, the spatial information output unit 66 determines that the lane with the first direction and lane with the second direction are represented by a single lane group LG. Thereafter, the processing of spatial information output unit 66 proceeds to step S204.

In step S204, following step S202, the spatial information output unit 66 splits the lane group information LG representing the lane with the first direction and lane with the second direction.

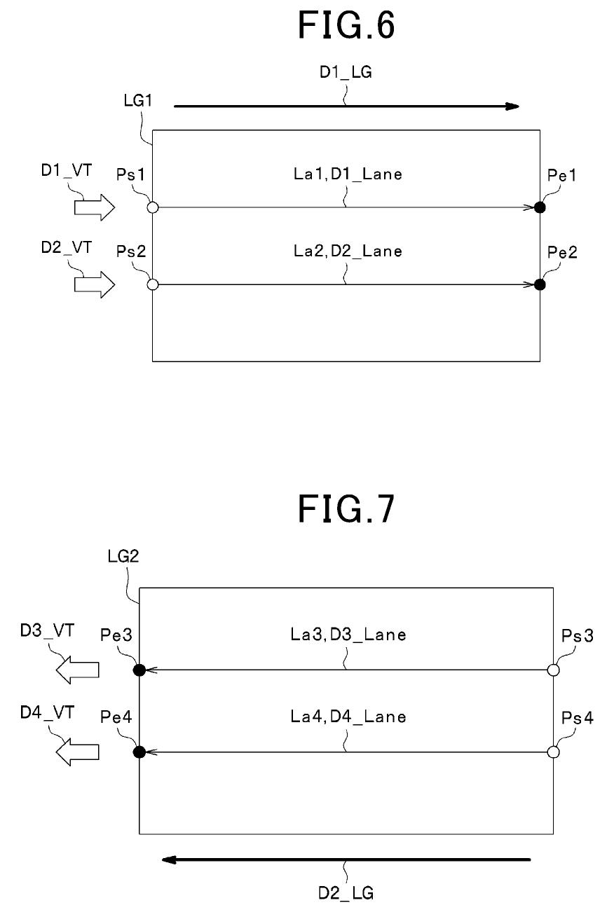

In the first example, as shown in FIGS. 6 and 7, the spatial information output unit 66 divides the lane group LG into first lane group information LG1 and second lane group information LG2.

As shown in FIG. 6, the first lane group information LG1 has a first lane information La1 and a second lane information La2. The first lane information La1 includes a first vehicle direction D1_VT and a first lane direction D1_Lane. The second lane information La2 includes a second vehicle direction D2_VT and a second lane direction D2_Lane. The spatial information output unit 66 newly assigns a first group direction D1_LG to the first lane group information LG1. The first group direction D1_LG is a digitizing direction of the first lane group information LG1, which is the same direction as the first lane direction ED1_Lane and the second lane direction ED2_Lane. The spatial information output unit 66 newly assigns a group identification number LGID to the first lane group information LG1. The spatial information output unit 66 newly assigns a lane identification number Lane ID to the first lane information La1. The spatial information output unit 66 newly assigns a lane identification number Lane ID to the second lane information La2. In FIG. 6, to avoid complexity, lane shape points P other than those for the start point Ps and end the point Pe, the group identification numbers LGID, and the lane identification numbers Lane ID are omitted.

As shown in FIG. 7, the second lane group information LG2 has a third lane information La3 and a fourth lane information La4. The third lane information La3 includes a third vehicle direction D3_VT and a fourth lane direction D4_Lane. The fourth lane information La4 includes a fourth vehicle direction D4_VT and a fourth lane direction D4_Lane. The spatial information output unit 66 newly assigns a second group direction D2_LG to the second lane group information LG2. The second group direction D2_LG is a digitizing direction of the second lane group information LG2, which is the same direction as the third lane direction ED3_Lane and the fourth lane direction ED4_Lane. The spatial information output unit 66 newly assigns a group identification number LGID to the second lane group information LG2. The spatial information output unit 66 newly assigns a lane identification number Lane ID to the third lane information La3. The spatial information output unit 66 newly assigns a lane identification number Lane ID to the fourth lane information La4. In FIG. 7, to avoid complexity, lane shape points P other than those for the start point Ps and end the point Pe, the group identification numbers LGID, and the lane identification numbers Lane ID are omitted.

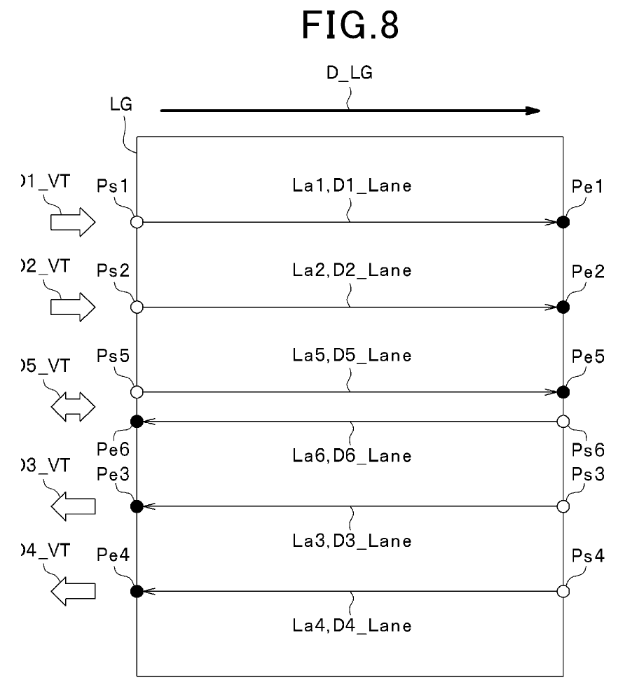

In a second example shown in FIG. 8, the lane group information LG of the first example includes a fifth lane information La5 and a sixth lane information La6 in addition to the first lane information La1, the second lane information La2, the third lane information La3, and the fourth lane information La4.In FIG. 8, to avoid complexity, lane shape points P other than those for the start point Ps and end the point Pe, the group identification numbers LGID, and the lane identification numbers Lane ID are omitted.

The fifth lane information La5 and the sixth lane information La6 share the fifth vehicle direction D5_VT. The fifth vehicle direction D5_VT is one of the vehicle directions. The fifth lane information La5 includes a fifth vehicle direction D5_VT, a fifth start point Ps5, a fifth end point Pe5, and a fifth lane direction D5_Lane. The fifth vehicle direction D5_VT is one of the vehicle directions. The fifth start point Ps5 is a start point of the lane represented by the fifth lane information La5. The fifth end point Pe5 is an end point of the lane represented by the fifth lane information La5. The fifth lane direction D5_Lane is a direction from the fifth start point Ps5 toward the fifth end point Pe5.

The sixth lane information La6 includes a sixth vehicle direction D6_VT, a sixth start point Ps6, a sixth end point Pe6, and a sixth lane direction D6_Lane. The sixth vehicle direction D6_VT is one of the vehicle directions. The sixth start point Ps6 is a start point of the lane represented by the sixth lane information La6. The sixth end point Pe6 is an end point of the lane represented by the sixth lane information La6. The sixth lane direction D6_Lane is a direction from the sixth start point Ps6 toward the sixth end point Pe6.

In the information Md, a reversible lane may be represented by a single lane group information LG. A reversible lane is in which the direction is changed according to a change of a center line that is shifted according to the time of day.

In this case, for example, the fifth vehicle direction D5_VT represents the direction of travel of vehicles on the reversible lane and may include the same direction as the first vehicle direction D1_VT, the second vehicle direction D2_VT, the third vehicle direction D3_VT, and the fourth vehicle direction D4_VT. Therefore, the fifth vehicle direction D5_VT is shown with a bidirectional arrow in FIG. 8. The fifth lane direction D5_Lane is set in the same direction as the first lane direction D1_Lane, the second lane direction D2_Lane, and the group direction D_LG. On the other hand, the sixth lane direction D6_Lane is set in the same direction as the third lane direction D3_Lane and the fourth lane direction D4_Lane. Thus, the reversible lane may be represented by the fifth vehicle direction D5_VT, the fifth lane information La5, and the sixth lane information La6.

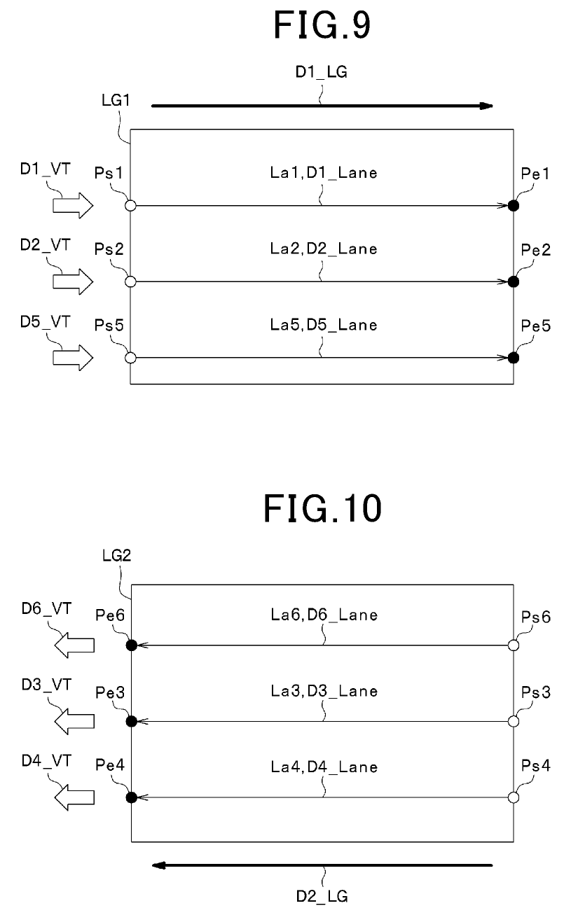

In this case, as shown in FIG. 9, when performing the division of lane group information LG, the spatial information output unit 66 may include the fifth lane information La5 in the first lane group information LG1. The spatial information output unit 66 may include the fifth vehicle direction D5_VT in the fifth lane information La5. As a result, the fifth vehicle direction D5_VT is changed to the same direction as the first vehicle direction D1_VT, the second vehicle direction D2_VT, the first lane direction ED1_Lane, and the second lane direction ED2_Lane. The spatial information output unit 66 assigns a new lane identification number Lane ID to the fifth lane information La5. In FIG. 9, to avoid complexity, lane shape points P other than those for the start point Ps and end the point Pe, the group identification numbers LGID, and the lane identification numbers Lane ID are omitted.

Furthermore, as shown in FIG. 10, the spatial information output unit 66 includes the sixth lane information La6 in the second lane group information LG2. The spatial information output unit 66 assigns a new sixth vehicle direction D6_VT to the sixth lane information La6. The sixth vehicle direction D6_VT is set in the same direction as the third vehicle direction D3_VT, the fourth vehicle direction D4_VT, the third lane direction E3_Lane, and the fourth lane direction E4_Lane. Furthermore, the spatial information output unit 66 newly assigns the lane identification number Lane ID to the sixth lane La6.

In this manner, by dividing the lane group information LG, the spatial information output unit 66 separates necessary data from unnecessary data during the processing of the control device 70, which corresponds to the processing using the map information Md. After the spatial information output unit 66 divides the lane group information LG, the processing of the spatial information output unit 66 proceeds to step S206.

Preparing the high-precision map information Md requires significant cost and effort. Furthermore, while it is desirable for the vehicle direction D_VT, the group direction D_LG, and the lane direction E_Lane to be identical in the processing of control device 70, the specifications of the high-precision map do not necessitate that they be the same. Consequently, the vehicle direction D_VT, the group direction D_LG, and the lane direction E_Lane may differ.

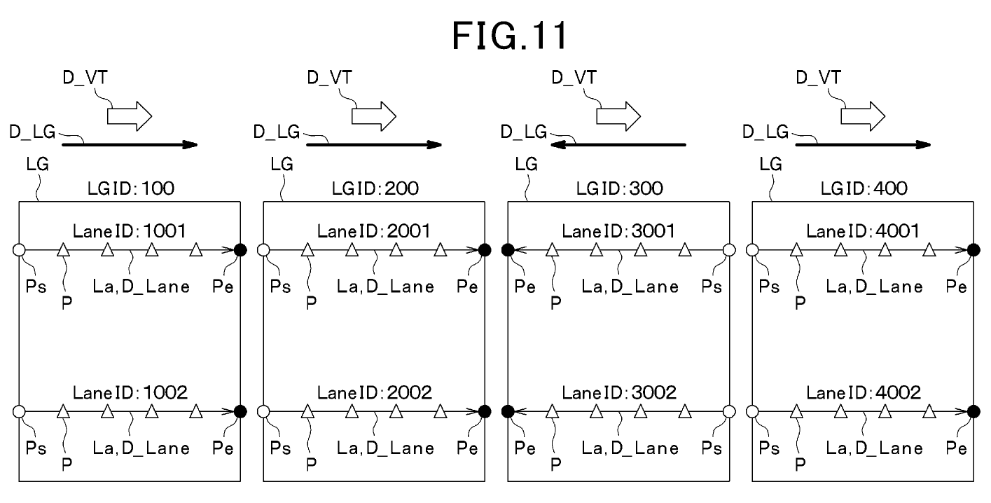

In a third example shown in FIG. 11, within the lane group information LG having group identification number LGID 300, the group direction D_LG is set to be a different direction from the vehicle direction D_VT. The start end of the lane group information LG with the group identification number LGID 300 is connected to the lane group information LG with the group identification number LGID 400. The terminal end of the lane group information LG with the group identification number LGID 300 is connected to the lane group information LG with the group identification number LGID 200. In this case, the lane group information LG with the group identification number LGID 300 contains information that, in the sequential relationship, 400 precedes 300 and 200 follows 300.

The lane group information LG with the group identification number LGID 300 includes the lane information La with the lane identification number Lane ID 3001 and the lane information La with the lane identification number Lane ID 3002.

The lane direction D_Lane of the lane information La with Lane ID 3001 is in the same direction as the group direction D_LG and in a different direction from the vehicle direction D_VT. The lane direction D_Lane of the lane information La with the lane identification number Lane ID 3002 is in the same direction as the group direction D_LG and in a different direction from the vehicle direction D_VT.

The start point Ps of the lane information La with the lane identification number Lane ID 3001 is connected to the start point Ps of the lane information La with the lane identification number Lane ID 4001.The end point Pe of the lane information La with the lane identification number Lane ID 3001 is connected to the end point Pe of lane information La with the lane identification number Lane ID 2001. In this case, the lane information La with the lane identification number Lane ID 3001 contains information indicating that in the sequential relationship, 4001 precedes 3001 and 2001 follows 3001.

The start point Ps of the lane information La with the lane identification number Lane ID 3002 is connected to the start point Ps of the lane information La with the lane identification number Lane ID 4002. The end point Pe of the lane information La with the lane identification number Lane ID 3002 is connected to the end point Pe of the lane information La with the lane identification number Lane ID 2002. In this case, the lane information La with the lane identification number Lane ID 3002 contains information that, in the sequential relationship, 4002 precedes 3002 and 2002 follows 3002.

Thus, the vehicle direction D_VT, the group direction D_LG, and the lane direction E_Lane may differ from one another.

Therefore, in step S206 of the flowchart shown in FIG. 4, the spatial information output unit 66 determines whether a lane group information LG where vehicle direction D_VT and group direction D_LG differ exists, using the map information Md acquired in step S200.

In a case that there is no lane group information LG where the vehicle direction D_VT and the group direction D_LG are different, the processing of the spatial information output unit 66 proceeds to step S210. In a case that a lane group information LG where vehicle direction D_VT and group direction D_LG are different exists, the processing of the spatial information output unit 66 proceeds to step S208.

In step S208, following step S206, the spatial information output unit 66 changes the lane group information LG.

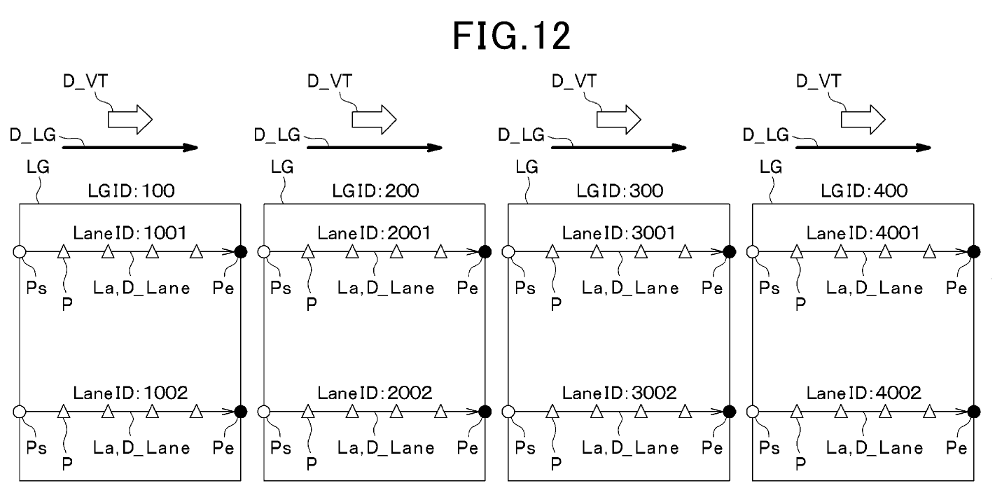

In the case of the example 3, as shown in FIG. 12, the spatial information output unit 66 changes the group direction D_LG of the lane group information _LG, whose group identification number LGID is 300, to the same direction as the vehicle direction D_VT. Furthermore, the spatial information output unit 66 changes the sequential relationship of the group identification number LGID. Specifically, the spatial information output unit 66 changes the information regarding the sequential relationship of 300 to indicate that 200 precedes 300 and 400 follows 300.

Also, in step S210 of the flowchart shown in FIG. 4, the spatial information output unit 66 determines whether a lane information La exists where the vehicle direction D_VT and the lane direction D_Lane differ in the map information Md acquired in step S200.

In a case that there is no lane information La where the vehicle direction D_VT and the lane direction D_Lane differ, the processing of the spatial information output unit 66 proceeds to step S214. In a case that there is lane information La where the vehicle direction D_VT and the lane direction D_Lane differ, the processing of the spatial information output unit 66 proceeds to step S212.

In step S212, following step S210, the spatial information output unit 66 changes the lane information La.

In the case of the third example, as shown in FIG. 12, the spatial information output unit 66 changes the lane direction D_Lane of the lane information La with the lane identification number Lane ID 3001 to the same direction as the vehicle direction D_VT. Furthermore, the spatial information output unit 66 changes the lane direction D_Lane of the lane information La with l the lane identification number Lane ID 3002 to the same direction as vehicle direction D_VT. Additionally, the spatial information output unit 66 changes the sequential relationship of the lane identification numbers. Specifically, the spatial information output unit 66 changes the information regarding the sequential relationship for 3001 to indicate that 2001 precedes 3001 and 4001 follows 3001. Furthermore, the spatial information output unit 66 changes the information regarding the sequential relationship for 3002 to indicate that 2002 precedes 3002 and 4002 follows 3002.

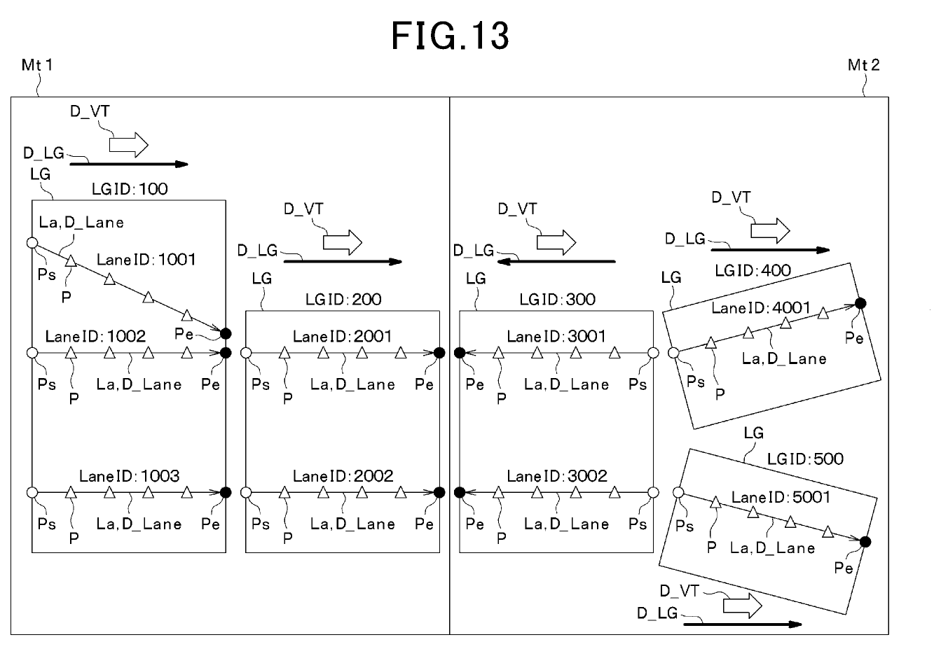

In the fourth example shown in FIG. 13, the map information Md has a first map tile information Mt1 and a second map tile information Mt2. The first map tile information Mt1 contains two lane group information LGs. The second map tile information Mt2 contains three lane group information LGs. A boundary between the first map tile information Mt1 and the second map tile information Mt2 lies between the lane group information LG with the group identification number LGID 200 and the lane group information LG with the group identification number LGID 300.

Due to constraints in the NDS specification, the group direction D_LG of the lane group information LGs straddling the boundary between the first map tile information Mt1 and the second map tile information Mt2 may have a different direction from the vehicle direction D_VT. Furthermore, due to constraints in the NDS specification, the lane direction D_Lane of the lane information Las straddling the boundary between the first map tile Mt1 and the second map tile information Mt2 may have a direction different from the vehicle direction D_VT.

Therefore, for example, the group direction D_LG of lane group information LG with the group identification number LGID 300 is assigned a direction different from the vehicle direction D_VT. In this case, the lane group information LG with the group identification number LGID 300 may contain information indicating that in the sequential relationship, 400 and 500 precede 300, and 000 follows 300. Furthermore, the lane direction D_Lane of the lane information La with the lane identification number Lane ID 3001 is in the same direction as the group direction D_LG and in a different direction from the vehicle direction D_VT. In this case, the lane information La with Lane ID 3001 contains information indicating that in the sequential relationship, 4001 precedes 3001, and 0000 follows 3001.The lane direction D_Lane of the lane information La with the lane identification number Lane ID 3002 is in the same direction as the group direction D_LG and in a different direction from the vehicle direction D_VT. In this case, The lane La with the lane identification number Lane ID 3002 contains information that in the sequential relationship, 5001 precedes 3002 and 0000 follows 3002.

In the case of the fourth example as well, the processing in steps S206, S208, S210, and S212 changes the lane group information _LG and the lane information _La.

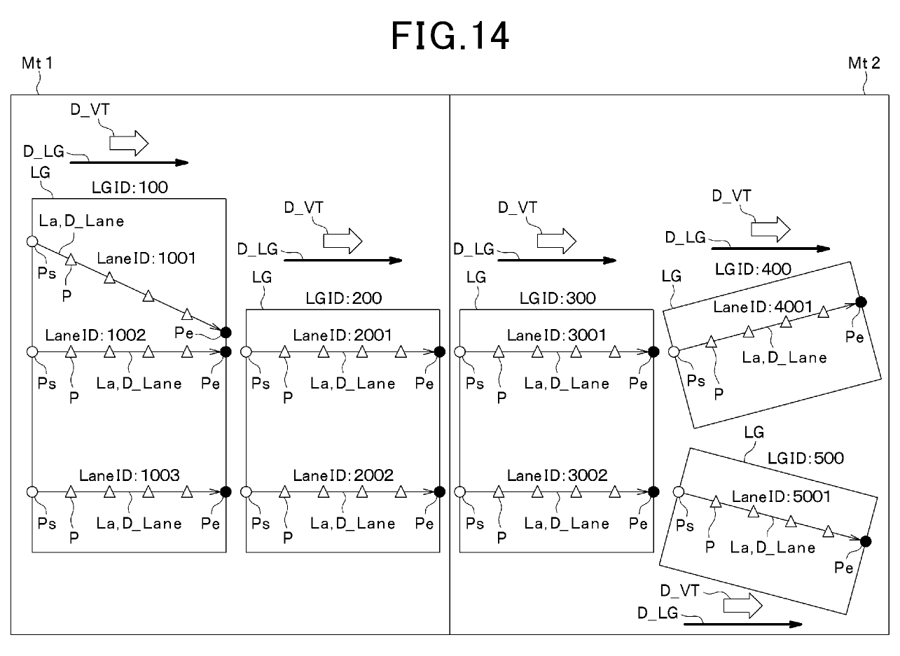

Specifically, as shown in FIG. 14, the spatial information output unit 66 changes the group direction D_LG of the lane group information LG with the group identification number LGID 300, to the same direction as the vehicle direction D_VT. Furthermore, the spatial information output unit 66 changes the sequential relationship of the group identification number LGID. Specifically, the spatial information output unit 66 changes the information regarding the sequential relationship of 300 to indicate that 000 precedes 300 and 400 and 500 follow 300.

Furthermore, the spatial information output unit 66 changes the direction of the lane direction D_Lane of the lane La with the lane identification number Lane ID 3001 to be the same as the vehicle direction D_VT. Additionally, the spatial information output unit 66 changes the ordering information for 3001 such that 3001 is preceded by 0000 and followed by 4001. Furthermore, the spatial information output unit 66 changes the lane direction D_Lane of the lane information La with the lane identification number Lane ID 3002, to the same direction as the vehicle direction D_VT. Additionally, the spatial information output unit 66 changes the ordering information for 3002 to indicate that 0000 precedes 3002 and 5001 follows 3002.

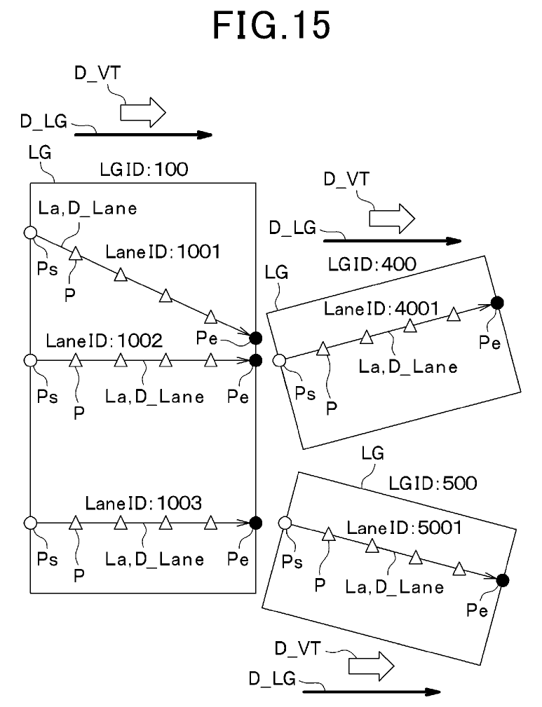

In the fourth example, in a case that each of the lane group information LG with the group identification numbers LGID 200 and 300 has only connection relationship information with other lane group information LGs and lack length information, the spatial information output unit 66 may delete the lane group information LGs with the group identification numbers LGID 200 and 300 as shown in FIG. 15, and modify the connection relationships and arrangement of the remaining lane groups LG and the lane information La.

After the spatial information output unit 66 modifies the lane group information LG and the lane information La in this manner, the processing of the spatial information output unit 66 proceeds to step S214.

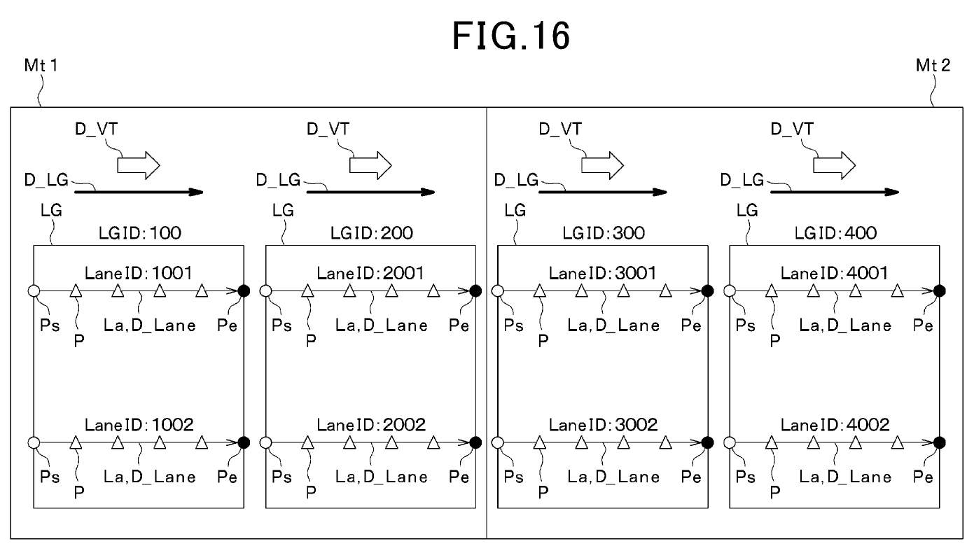

In the fifth example shown in FIG. 16, the map information Md has a first map tile information Mt1 and a second map tile information Mt2. The first map tile information Mt1 includes two lane group information LGs. The second map tile information Mt2 includes two lane group information LGs. A boundary between the first map tile information Mt1 and the second map tile information Mt2 exists between the lane group information LG with the group identification number LGID 200 and the lane group information LG with the group identification number LGID 300.

The terminal end of the lane group information LG with the group identification number LGID 200 is connected to the start end of the lane group information LG with the group identification number LGID 300. Furthermore, the terminal end of the lane information La with the lane identification number Lane ID 2001 is connected to the start end of the lane information La with the lane identification number Lane ID 3001.The end point of the lane information La with the lane identification number Lane ID 2002 is connected to the start point of the lane information La with the lane identification number Lane ID 3002.

In this case, the NDS contains information regarding the latitude, longitude, and altitude of the lane group information LG with the group identification number LGID 200, at the boundary between the first map tile information Mt1 and the second map tile information Mt2. However, there is no indication of the connection relationship and the arrangement relationship of two of the lane group information LGs spanning the first map tile information Mt1 and the second map tile information Mt2. Furthermore, there is no indication of the connection relationship and the arrangement relationship of the lane information La, which straddles the first map tile information Mt1 and the second map tile information Mt2.

Therefore, in the case of the fifth example, it is difficult to recognize the connection and the arrangement relationships of the lane group information LG with the group identification numbers LGID 200 and 300. Furthermore, it is difficult to recognize the connection and the arrangement relationships of the lane information La with the lane identification numbers Lane ID 2001 and 3001. The connection and the arrangement relationships of lane La with lane identification numbers Lane ID 2002 and 3002 are difficult to recognize.

Furthermore, in the processing corresponding to the control device 70 using the map information Md, it is necessary to recognize the connection and the arrangement relationships of the lane group information LG straddling the boundary between the first map tile Mt1 and the second map tile information Mt2. Furthermore, in the processing corresponding to control device 70 using map information Md, it is necessary to recognize the connection and arrangement relationships of lane La straddling the boundary between the first map tile information Mt1 and the second map tile information Mt2.

Therefore, in step S214 of the flowchart shown in FIG. 4, the spatial information output unit 66 determines whether the map information Md acquired in step S200 contains boundaries of map tile information Mt.

In a case that there is no boundary for the map tile information Mt in the map information Md, the processing of the spatial information output unit 66 proceeds to step S218. On the other hand, in a case that there is a boundary for the map tile information Mt in the map information Md, the processing of the spatial information output unit 66 proceeds to step S216.

In step S216, following step S214, the spatial information output unit 66 assigns a group identification number LGID associated with the group identification number LGID of the lane group information LG that straddles the boundary of the map tile Mt. Furthermore, the spatial information output unit 66 assigns a lane identification number Lane ID associated with the lane identification number Lane ID concerning the lane information La straddling the boundary of the map tile information Mt. Through these actions, the spatial information output unit 66 performs information supplementation.

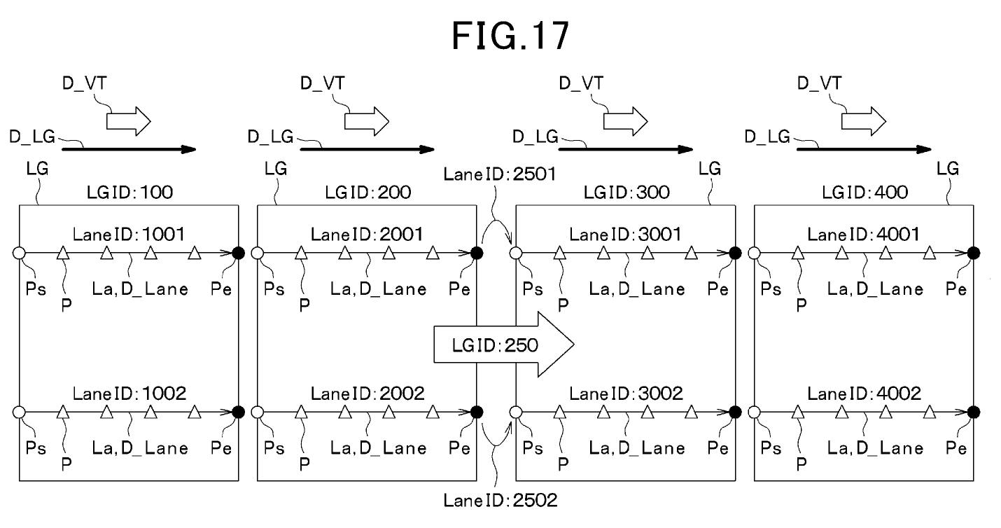

In the case of the fifth example, as shown in FIG. 17, the spatial information output unit 66 may assign, for example, 250 as the group identification number LGID associated with the group identification numbers LGID of the lane group information LG 200 and 300. Furthermore, the spatial information output unit 66 assigns information indicating that 200 precedes 250 and 300 follows 250 in the sequential relationship.

Furthermore, the spatial information output unit 66 may assign, for example, 2501 as the lane identification number Lane ID associated with the lane identification numbers Lane ID of lane information La with the lane identification numbers Lane ID 2001 and 3001. Furthermore, the spatial information output unit 66 assigns the information indicating that 2501 is preceded by 2001 and followed by 3001 in the sequential relationship.

Furthermore, the spatial information output unit 66 may assign, for example, 2502 as the lane identification number Lane ID associated with the lane identification numbers Lane ID 2002 and 3002. Furthermore, the spatial information output unit 66 may assign information indicating that 2002 precedes 2502 and 3002 follows 2502 in the sequential relationship.

In this way, by the spatial information output unit 66 performing the information supplementation, the connection relationship and the sequential relationship of two of the lane group information LG straddling the boundary of the map tile information Mt become easier to recognize. Furthermore, the connection relationship and the sequential relationship of the two of the lane information La straddling the boundary of the map tile information Mt become easier to recognize. After the spatial information output unit 66 performs the information supplementation, the processing of the spatial information output unit 66 proceeds to step S218.

In step S218, the spatial information output unit 66 outputs the modified map information Md as the spatial information Ms to the autonomous driving ECU 50. The spatial information Ms output to the autonomous driving ECU 50 is fused with information from the camera sensor 34 and the probe wave sensor 36 by the fusion processing unit 72. The spatial information Ms fused with the information from the camera sensor 34 and the probe wave sensor 36 by the fusion processing unit 72 is used to determine the current position of the own vehicle 20 by the localization unit 74. The spatial information Ms, fused with the information from the camera sensor 34 and the probe wave sensor 36 by the fusion processing unit 72, and for which the current position of the own vehicle 20 has been determined by the localization unit 74, is used for autonomous control of the behavior of the own vehicle 20 by the driving operation unit 76. After that, the processing of the spatial information output unit 66 returns to step S200.

As described above, the spatial information output unit 66 performs the processing. Next, how the spatial information output device 60 unifies the directions concerning vehicle direction and lane group information LG will be explained.

In step S200 of the flowchart shown in FIG. 4, the spatial information output unit 66 of the spatial information output device 60 functions as an acquisition unit that acquires the map information Md for an area determined based on the position of the own vehicle 20. Furthermore, the spatial information output unit 66 functions as an output unit that modifies the information contained in the acquired map information Md and outputs the modified map information Md. Specifically, in steps S206 and S208, the spatial information output unit 66 changes the group direction D_LG to the vehicle direction D_VT when the group direction D_LG differs from the vehicle direction D_VT.

This processing unifies the vehicle direction D_VT and the group direction D_LG, thereby unifying the directions related to the vehicle direction and the lane group information _LG.

Furthermore, since the vehicle direction D_VT and the group direction D_LG are unified, it becomes unnecessary to perform direction unification processing for each operation of the fusion processing unit 72, the localization unit 74, and the driving operation unit 76 in the control device 70, which correspond to processing using the map information Md. Consequently, processing load of the control device 70 is suppressed.

Moreover, the spatial information output unit 66 of this embodiment also achieves the following effects.

[1] Similar to the lack of unified of the vehicle direction and the group direction, there may be cases where the vehicle direction and the lane information are not unified.

Therefore, in steps S210 and S212, the spatial information output unit 66 changes the lane direction D_Lane to vehicle direction D_VT in a case that the lane direction D_Lane differs from vehicle the direction D_VT.

This processing unifies the vehicle direction D_VT and the lane direction _D_Lane, thereby unifying the direction for vehicle direction and the lane information _La.

[2] In steps S202 and S204, the spatial information output unit 66 divides the lane group LG in a case that multiple distinct vehicle directions D_VT exist within a single lane group information LG.

This processing separates necessary data from unnecessary data for the processing of the fusion processing unit 72, the localization unit 74, and the driving operation unit 76 in the control device 70, which corresponds to processing using the map information Md.

[3] In steps S214 and S216, in a case that a map tile Mt has a boundary, the spatial information output unit 66 assigns a group identification number LGID associated with the group identification number LGID of two of the lane group information LGs straddling the boundary of the map tile information Mt. Furthermore, the spatial information output unit 66 assigns a lane identification number Lane ID associated with the lane identification number Lane ID of two of the lane information Las straddling the boundary of map tile information Mt. Through these actions, the spatial information output unit 66 performs the information supplementation.

This makes it easier to recognize the connection relationships and the arrangement relationships of two of the lane group information LGs straddling the boundary of map tile information Mt. It also makes it easier to recognize the connection relationships and the arrangement relationships of two of the lane information La straddling the boundary of map tile information Mt.

### Another Embodiments

The present disclosure is not limited to the above embodiments and may be appropriately modified with respect to the above embodiments. Furthermore, it goes without saying that the elements constituting the embodiments described above are not necessarily essential, except where explicitly stated as essential or where they are clearly essential in principle.

The acquisition unit, output unit, etc., and their methods described herein may be implemented by a dedicated computer provided by configuring a processor and memory programmed to execute one or more functions embodied by a computer program. Alternatively, the acquisition unit, output unit, etc., and their methods described herein may be implemented by a dedicated computer provided by configuring a processor using one or more dedicated hardware logic circuits. Alternatively, the acquisition unit, output unit, etc., and the method described herein may be implemented by one or more dedicated computers configured by a combination of a processor and memory programmed to execute one or more functions, and one or more hardware logic circuits. Furthermore, the computer program may be stored on a computer-readable, non-transitory tangible recording medium as instructions executable by a computer.

In the above embodiment, the spatial information output device 60 is incorporated into the autonomous driving ECU 50 because it is provided in the autonomous driving ECU 50. However, the spatial information output device 60 is not limited to being incorporated into the autonomous driving ECU 50. The spatial information output device 60 may be provided separately from the autonomous driving ECU 50 in the own vehicle 20 itself.

In the above embodiment, the lane group information LG has the vehicle direction D_VT, the lane information La, the group direction D_LG, and the group identification number LGID. In contrast, the lane group LG may additionally include information such as road edge type, road edge shape points, road speed limit, and road type as road attribute information. The road edge type may be, for example, a curb or guardrail. The road edge shape point is a point indicating the road edge's position. The road speed limit is, for example, the maximum speed specified by signs for each road section. The road type may be, for example, an expressway or a general road. A highway is a main road connecting areas of political, economic, or cultural importance, such as major cities, industrial cities, major ports, and airports. It is a road legally and structurally designed to enable vehicles to travel at high speeds safely and comfortably. In Japan, highways refer to expressways and motorways. General roads refer to roads other than highways.

When the lane group information LG contains road attribute information, the spatial information output unit 66 changes the corresponding road attribute information when modifying the information related to the lane group LG.

In the above embodiment, the lane information La has the lane shape points P, the lane direction D_Lane, and the lane identification number Lane ID. In contrast, the lane information La may additionally include information regarding shape points of the centerline of lanes on the road and shape points of lane dividing lines on the road, etc., as lane attribute information. The shape point of the centerline of a road lane is a point indicating the position of that centerline. The shape points of the lane dividing lines on the road are points indicating the position of those dividing lines.

When the lane information La contains the lane attribute information, the spatial information output unit 66 changes the lane attribute information corresponding to that the lane information La when modifying information related to the lane information La.

The above embodiments may be appropriately combined.

### Aspects of this disclosure

### Aspect 1

A spatial information output device comprising:

an acquisition unit configured to acquire map information (Md) about an area determined based on position of a vehicle; and

an output unit configured to modify information contained in the map information and outputs the modified map information,

wherein the map information comprises at least one map tile information,

each of the at least one map tile information (Mt) comprises at least one lane group information,

each of the at least one lane group information comprises at least one lane information and a group direction (D_LG),

each of the at least one lane information comprises a start point (Ps) and an end point (Pe) of a corresponding lane (La) , and a vehicle direction (D_VT) which is related to a vehicle,

the group direction is a direction corresponding to the lane group information and either a direction from the start point toward the end point or a direction from the end point toward the start point, and

the output unit changes the group direction to the vehicle direction in a case that the group direction differs from the vehicle direction.

### Aspect 2

The spatial information output device according to aspect 1, wherein

each of the at least one lane information further comprises a lane direction (D_Lane), which is a direction from the start point to the end point, and

the output unit changes the lane direction to the vehicle direction in a case that the lane direction differs from the vehicle direction.

### Aspect 3

The spatial information output device according to aspect 1, wherein

the at least one lane group information includes first lane group information and second lane group information,

the first lane group information comprises first lane information and first group direction,

the first lane information comprises a first start point and a first end point, and a first vehicle direction,

the first group direction is a direction corresponding to the first lane group information and either a direction from the first start point toward the first end point or a direction from the first end point toward the first start point,

the second lane group information comprises second lane information and a second group direction,

the second lane information comprises a second start point and a second end point, and a second vehicle direction,

the second group direction is a direction corresponding to the second lane group information and either a direction from the second start point toward the second end point or a direction from the second end point toward the second start point,

an identification number of the first lane group information and an identification number for the second lane group information have sequential relationship,

the output unit changes the first group direction to the first vehicle direction in a case that the first group direction differs from the first vehicle direction and changes the sequential relationship between the identification number of the first lane group information and the identification number of the second lane group information, and

the output unit changes the second group direction to the second vehicle direction in a case that the second group direction differs from the second vehicle direction and changes the sequential relationship between the identification number of the first lane group information and the identification number of the second lane group information.

### Aspect 4

The spatial information output device according to aspect 1, wherein

the at least one map tile information includes first map tile information and second map tile information,

the first map tile information comprises first lane group information,

the first lane group information comprises first lane information and a first group direction,

the first lane information comprises a first start point and a first end point, and a first vehicle direction,

the first group direction is a direction corresponding to the first lane group information and either a direction from the first start point toward the first end point or a direction from the first end point toward the first start point,

the second map tile information comprises second lane group information,

the second lane group information comprises second lane information and a second group direction,

the second lane information comprises a second start point and a second end point, and a second vehicle direction,

the second group direction is direction corresponding to the second lane group information and either a direction from the second start point toward the second end point or a direction from the second end point toward the second start point,

an identification number of the first lane group information and an identification number of the second lane group information have sequential relationship,

the output unit changes the first group direction to the first vehicle direction in a case that the first group direction differs from the first vehicle direction and changes the sequential relationship between the identification number of the first lane group information and the identification number of the second lane group information, and

the output unit changes the second group direction to the second vehicle direction in a case that the second group direction differs from the second vehicle direction and changes the sequential relationship between the identification number of the first lane group information and the identification number of the second lane group information.

### Aspect 5

The spatial information output device according to aspect 3, wherein

the first lane information further comprises a first lane direction which is a direction from the first start point toward the first end point,

the second lane information further comprises a second lane direction which is a direction from the second start point toward the second end point,

an identification number of the first lane information and an identification number for the second lane have sequential relationship,

the output unit changes the first lane direction to the first vehicle direction and changes the sequential relationship between the identification number of the first lane information and the identification number of the second lane in a case that the first lane direction differs from the first vehicle direction, and

the output unit changes the second direction to the second vehicle direction and changes the sequential relationship between the identification number of the first lane information and the identification number of the second lane in a case that the second lane direction differs from the second vehicle direction.

### Aspect 6

The spatial information output device according to aspect 4 wherein

the first lane information further comprises a first lane direction which is a direction from the first start point toward the first end point,

the second lane information further comprises a second lane direction which is a direction from the second start point toward the second end point,

an identification number of the first lane information and an identification number for the second lane have sequential relationship,

the output unit changes the first lane direction to the first vehicle direction and changes the sequential relationship between the identification number of the first lane information and the identification number of the second lane in a case that the first lane direction differs from the first vehicle direction, and

the output unit changes the second direction to the second vehicle direction and changes the sequential relationship between the identification number of the first lane information and the identification number of the second lane in a case that the second lane direction differs from the second vehicle direction.

### Aspect 7

The spatial information output device according to aspect 1, wherein

the at least one lane information includes first lane information and second lane information,

the first lane information comprises a first start point and a first end point of a first lane, and a first vehicle direction which is related to a vehicle,

the second lane information comprises a second start point and a second end point of a second, and a second vehicle direction which is related to a vehicle, and

in a case that the first vehicle direction and the first lane direction are in the same direction, the second vehicle direction and the second lane direction are in the same direction, and the first vehicle direction and the second vehicle direction are in different directions, the output unit:

divides lane group information into first lane group information comprising the first vehicle direction and the first lane information, and second lane group information comprising the second vehicle direction and the second lane information;

assigns a first group direction corresponding to the direction from the first start point toward the first end point to the first lane group information; and

assigns a second group direction corresponding to the direction from the second start point toward the second end point to the second lane group information.

### Aspect 8

The spatial information output device described according to aspect 7, wherein

when dividing the lane group information into the first lane group and the second lane group, the output unit assigns respective identification numbers to the first lane group information, the second lane group information, the first lane information, and the second lane information.

### Aspect 9

The spatial information output device according to aspect 1, wherein

the at least one map tile information includes first map tile information and second map tile information,

the first map tile information comprises first lane group information,

the first lane group information comprises first lane information,

the first lane information comprises a first start point and a first end point of the first lane, and a first vehicle direction which is related to a vehicle,

the second map tile information comprises second lane group information,

the second lane group information comprises second lane information,

the second lane information comprises a second start point and a second end point of the second lane, and a second vehicle direction which is related to a vehicle,

in a case that a boundary between a lane group represented by the first lane group information and a lane group represented by the second lane group information is a boundary between the first map tile information and the second map tile information, the output unit assigns mutually related identification numbers to the first lane group information and the second lane group information respectively.

### Aspect 10

The spatial information output device according to aspect 9, wherein

when assigning dentification numbers to the first lane group information and the second lane group information respectively, the output unit assigns mutually related identification numbers to the first lane information and the second lane information respectively.

### Aspect 11

A spatial information output method performed by a computer comprising:

acquiring map information about an area determined based on position of a vehicle; and

modifying information contained in the map information and outputs the modified map information,

wherein the map information comprises at least one map tile information,

each of the at least one map tile information comprises at least one lane group information,

each of the at least one lane group information comprises at least one lane information and a group direction,

each of the at least one lane information comprises a start point and an end point of a corresponding lane, and a vehicle direction which is related to a vehicle,

the group direction is a direction corresponding to the lane group information and either a direction from the start point toward the end point or a direction from the end point toward the start point, and

the modification includes changing the group direction to the vehicle direction in a case that the group direction differs from the vehicle direction.

### Aspect 12

A non-transitory computer-readable storage medium storing a spatial information output program, the spatial information output program causing a processor to perform:

acquiring map information about an area determined based on position of a vehicle; and

modifying information contained in the map information and outputs the modified map information,

wherein the map information comprises at least one map tile information,

each of the at least one map tile information comprises at least one lane group information,

each of the at least one lane group information comprises at least one lane information and a group direction,

each of the at least one lane information comprises a start point and an end point of a corresponding lane, and a vehicle direction which is related to a vehicle,

the group direction is a direction corresponding to the lane group information and either a direction from the start point toward the end point or a direction from the end point toward the start point, and

the modification includes changing the group direction to the vehicle direction in a case that the group direction differs from the vehicle direction.

What is claimed is:

1. A spatial information output device comprising:
an acquisition unit configured to acquire map information about an area determined based on position of a vehicle; and
an output unit configured to modify information contained in the map information and outputs the modified map information,
wherein the map information comprises at least one map tile information,
each of the at least one map tile information comprises at least one lane group information,
each of the at least one lane group information comprises at least one lane information and a group direction,
each of the at least one lane information comprises a start point and an end point of a corresponding lane, and a vehicle direction which is related to a vehicle,
the group direction is a direction corresponding to the lane group information and either a direction from the start point toward the end point or a direction from the end point toward the start point, and
the output unit changes the group direction to the vehicle direction in a case that the group direction differs from the vehicle direction.

2. The spatial information output device according to claim 1, wherein
each of the at least one lane information further comprises a lane direction, which is a direction from the start point to the end point, and
the output unit changes the lane direction to the vehicle direction in a case that the lane direction differs from the vehicle direction.

3. The spatial information output device according to claim 1, wherein
the at least one lane group information includes first lane group information and second lane group information,
the first lane group information comprises first lane information and first group direction,
the first lane information comprises a first start point and a first end point, and a first vehicle direction,
the first group direction is a direction corresponding to the first lane group information and either a direction from the first start point toward the first end point or a direction from the first end point toward the first start point,
the second lane group information comprises second lane information and a second group direction,
the second lane information comprises a second start point and a second end point, and a second vehicle direction,
the second group direction is a direction corresponding to the second lane group information and either a direction from the second start point toward the second end point or a direction from the second end point toward the second start point,
an identification number of the first lane group information and an identification number for the second lane group information have sequential relationship,
the output unit changes the first group direction to the first vehicle direction in a case that the first group direction differs from the first vehicle direction and changes the sequential relationship between the identification number of the first lane group information and the identification number of the second lane group information, and
the output unit changes the second group direction to the second vehicle direction in a case that the second group direction differs from the second vehicle direction and changes the sequential relationship between the identification number of the first lane group information and the identification number of the second lane group information.

4. The spatial information output device according to claim 1, wherein
the at least one map tile information includes first map tile information and second map tile information,
the first map tile information comprises first lane group information,
the first lane group information comprises first lane information and a first group direction,
the first lane information comprises a first start point and a first end point, and a first vehicle direction,
the first group direction is a direction corresponding to the first lane group information and either a direction from the first start point toward the first end point or a direction from the first end point toward the first start point,
the second map tile information comprises second lane group information,
the second lane group information comprises second lane information and a second group direction,
the second lane information comprises a second start point and a second end point, and a second vehicle direction,
the second group direction is direction corresponding to the second lane group information and either a direction from the second start point toward the second end point or a direction from the second end point toward the second start point,
an identification number of the first lane group information and an identification number of the second lane group information have sequential relationship,
the output unit changes the first group direction to the first vehicle direction in a case that the first group direction differs from the first vehicle direction and changes the sequential relationship between the identification number of the first lane group information and the identification number of the second lane group information, and
the output unit changes the second group direction to the second vehicle direction in a case that the second group direction differs from the second vehicle direction and changes the sequential relationship between the identification number of the first lane group information and the identification number of the second lane group information.

5. The spatial information output device according to claim 3, wherein
the first lane information further comprises a first lane direction which is a direction from the first start point toward the first end point,
the second lane information further comprises a second lane direction which is a direction from the second start point toward the second end point,
an identification number of the first lane information and an identification number for the second lane have sequential relationship,
the output unit changes the first lane direction to the first vehicle direction and changes the sequential relationship between the identification number of the first lane information and the identification number of the second lane in a case that the first lane direction differs from the first vehicle direction, and
the output unit changes the second direction to the second vehicle direction and changes the sequential relationship between the identification number of the first lane information and the identification number of the second lane in a case that the second lane direction differs from the second vehicle direction.

6. The spatial information output device according to claim 4, wherein
the first lane information further comprises a first lane direction which is a direction from the first start point toward the first end point,
the second lane information further comprises a second lane direction which is a direction from the second start point toward the second end point,
an identification number of the first lane information and an identification number for the second lane have sequential relationship,
the output unit changes the first lane direction to the first vehicle direction and changes the sequential relationship between the identification number of the first lane information and the identification number of the second lane in a case that the first lane direction differs from the first vehicle direction, and
the output unit changes the second direction to the second vehicle direction and changes the sequential relationship between the identification number of the first lane information and the identification number of the second lane in a case that the second lane direction differs from the second vehicle direction.

7. The spatial information output device according to claim 1, wherein
the at least one lane information includes first lane information and second lane information,
the first lane information comprises a first start point and a first end point of a first lane, and a first vehicle direction which is related to a vehicle,
the second lane information comprises a second start point and a second end point of a second, and a second vehicle direction which is related to a vehicle, and
in a case that the first vehicle direction and the first lane direction are in the same direction, the second vehicle direction and the second lane direction are in the same direction, and the first vehicle direction and the second vehicle direction are in different directions, the output unit:
divides lane group information into first lane group information comprising the first vehicle direction and the first lane information, and second lane group information comprising the second vehicle direction and the second lane information;
assigns a first group direction corresponding to the direction from the first start point toward the first end point to the first lane group information; and
assigns a second group direction corresponding to the direction from the second start point toward the second end point to the second lane group information.

8. The spatial information output device described according to claim 7, wherein
when dividing the lane group information into the first lane group and the second lane group, the output unit assigns respective identification numbers to the first lane group information, the second lane group information, the first lane information, and the second lane information.

9. The spatial information output device according to claim 1, wherein
the at least one map tile information includes first map tile information and second map tile information,
the first map tile information comprises first lane group information,
the first lane group information comprises first lane information,
the first lane information comprises a first start point and a first end point of the first lane, and a first vehicle direction which is related to a vehicle,
the second map tile information comprises second lane group information,
the second lane group information comprises second lane information,
the second lane information comprises a second start point and a second end point of the second lane, and a second vehicle direction which is related to a vehicle,
in a case that a boundary between a lane group represented by the first lane group information and a lane group represented by the second lane group information is a boundary between the first map tile information and the second map tile information, the output unit assigns mutually related identification numbers to the first lane group information and the second lane group information respectively.

10. The spatial information output device according to claim 9, wherein
when assigning dentification numbers to the first lane group information and the second lane group information respectively, the output unit assigns mutually related identification numbers to the first lane information and the second lane information respectively.

11. A spatial information output method performed by a computer comprising:
acquiring map information about an area determined based on position of a vehicle; and
modifying information contained in the map information and outputs the modified map information,
wherein the map information comprises at least one map tile information,
each of the at least one map tile information comprises at least one lane group information,
each of the at least one lane group information comprises at least one lane information and a group direction,
each of the at least one lane information comprises a start point and an end point of a corresponding lane, and a vehicle direction which is related to a vehicle,
the group direction is a direction corresponding to the lane group information and either a direction from the start point toward the end point or a direction from the end point toward the start point, and
the modification includes changing the group direction to the vehicle direction in a case that the group direction differs from the vehicle direction.

12. A non-transitory computer-readable storage medium storing a spatial information output program, the spatial information output program causing a processor to perform:
acquiring map information about an area determined based on position of a vehicle; and
modifying information contained in the map information and outputs the modified map information,
wherein the map information comprises at least one map tile information,
each of the at least one map tile information comprises at least one lane group information,
each of the at least one lane group information comprises at least one lane information and a group direction,
each of the at least one lane information comprises a start point and an end point of a corresponding lane, and a vehicle direction which is related to a vehicle,
the group direction is a direction corresponding to the lane group information and either a direction from the start point toward the end point or a direction from the end point toward the start point, and
the modification includes changing the group direction to the vehicle direction in a case that the group direction differs from the vehicle direction.
